(19) United States
(12) Patent Application Publication
(10) Pub. No.: US 2011/0141866 A1
(43) Pub. Date: Jun. 16, 2011

(54) TRACKING SIGNAL GENERATION DEVICE AND METHOD, REPRODUCTION DEVICE AND METHOD, AND COMPUTER PROGRAM

(75) Inventors: Mitsuru Sato, Tokorozawa-Shi (JP); Shogo Miyanabe, Tokorozawa-Shi (JP); Junichi Furukawa, Tokorozawa-Shi (JP)

(73) Assignee: PIONEER CORPORATION, TOKYO (JP)

(21) Appl. No.: 12/674,231

(22) PCT Filed: Aug. 22, 2007
(86) PCT No.: PCT/JP2007/066245

§ 371 Date: May 6, 2010

(51) Int. Cl. G11B 20/10

(52) U.S. Cl. 369/47.15; G9B/20.009

(57) ABSTRACT

A tracking signal generating apparatus is provided with: a reading device for reading reflected light of a laser beam applied onto a recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; and a generating device for performing a phase comparison process on the equalization-corrected signal, thereby generating the tracking signal.

### TECHNICAL FIELD

The present invention relates to a tracking signal generating apparatus for and method of generating a tracking signal for performing tracking control, a reproducing apparatus and method which is provided with the tracking signal generating apparatus, a computer program which makes a computer function as the tracking signal generating apparatus, a recording apparatus, or the reproducing apparatus, as well as a recording medium.

### BACKGROUND ART

In an optical disc, such as a CD, a DVD, and a Blu-ray disc, tracking control is performed in order to preferably apply a recording/reproducing laser beam onto a data pattern (e.g. a combination of a record mark, a record pit, a space, and the like) recorded on the optical disc or a recording track in which the data pattern is to be recorded. The tracking control enables the data pattern to be accurately read or to be recorded at a preferable position.

As a method of the tracking control, a push-pull method, a three-beam method, and a DPD (Differential Phase Detection) method are listed as one example. Of those methods, in the DPD method, the phases of read signals (in other words, light-receiving signals) from a light-receiving element provided with a plurality of light-receiving areas are compared, and a tracking signal is generated on the basis of the comparison result. In particular, in a patent document 1, in order to improve the accuracy of the tracking signal, such a method is adopted that the tracking signal is generated on the basis of the read signals in which a signal component caused by a data pattern with a relatively short run length (in other words, pit length) is removed.

Patent document 1: Japanese Patent Application Laid Open No. 2006-53968

### DISCLOSURE OF INVENTION

### Subject to be Solved by the Invention

However, the probability of appearance of the data pattern with the relatively short run length (e.g. a data pattern with a run length of 3 T or the like in the DVD as one example of the optical disc, and a data pattern with a run length of 2 T or the like in the Blu-ray Disc as one example of the optical disc) is generally higher than that of a data pattern with a relatively long run length. In view of this, it is considered that the generation of the tracking signal by effectively using the data pattern with the relatively short run length further improves the accuracy of the tracking signal.

In view of the aforementioned problems, it is therefore an object of the present invention to provide, for example, a tracking signal generating apparatus and method, which can further improve the accuracy of the tracking signal when performing the tracking control using, for example, the DPD method, a reproducing apparatus and method, and a computer program.

### Means for Solving the Subject

The above object of the present invention can be achieved by a tracking signal generating apparatus for generating a tracking signal for performing tracking control which uses a DPD (Differential Phase Detection) method, the tracking signal generating apparatus provided with: a reading device for reading reflected light of a laser beam applied onto a recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; and a generating device for performing a phase comparison process on the equalization-corrected signal, thereby generating the tracking signal.

The above object of the present invention can be also achieved by a tracking signal generating method of generating a tracking signal for performing tracking control which uses a DPD (Differential Phase Detection) method, the tracking signal generating method provided with: a reading process of reading reflected light of a laser beam applied onto a recording medium, thereby obtaining a resulting read signal; an amplitude-limiting process of limiting an amplitude level of the read signal by a predetermined amplitude value, thereby obtaining an amplitude limit signal; a filtering process of performing a high-frequency emphasis filtering process on the amplitude limit signal, thereby obtaining an equalization-corrected signal; and a generating process of performing a phase comparison process on the equalization-corrected signal, thereby generating the tracking signal.

The above object of the present invention can be also achieved by a reproducing apparatus for reproducing data recorded on a recording medium while generating a tracking signal for performing tracking control which uses a DPD (Differential Phase Detection) method, the reproducing apparatus provided with: a reading device for reading reflected light of a laser beam applied onto the recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; a generating device for performing a phase comparison process on the equalization-corrected signal, thereby generating the tracking signal; and a reproducing device for reproducing the data recorded on the recording medium while performing the tracking control on the basis of the generated tracking signal.

The above object of the present invention can be also achieved by a reproducing method of reproducing data recorded on a recording medium while generating a tracking signal for performing tracking control which uses a DPD (Differential Phase Detection) method, the reproducing method provided with: a reading process of reading reflected light of a laser beam applied onto the recording medium, thereby obtaining a resulting read signal; an amplitude-limiting process of limiting an amplitude level of the read signal by a predetermined amplitude value, thereby obtaining an amplitude limit signal; a filtering process of performing a high-frequency emphasis filtering process on the amplitude limit signal, thereby obtaining an equalization-corrected signal; a generating process of performing a phase comparison process on the equalization-corrected signal, thereby generating the tracking signal; and a reproducing process of reproducing the data recorded on the recording medium while performing the tracking control on the basis of the generated tracking signal.

The above object of the present invention can be also achieved by a first computer program for controlling a computer provided in a tracking signal generating apparatus for generating a tracking signal for performing tracking control which uses a DPD (Differential Phase Detection) method, the tracking signal generating apparatus provided with: a reading device for reading reflected light of a laser beam applied onto a recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; and a generating device for performing a phase comparison process on the equalization-corrected signal, thereby generating the tracking signal, the computer program making the computer function as at least one portion of the reading device, the amplitude-limiting device, the filtering device, and the generating device.

The above object of the present invention can be also achieved by a second computer program for controlling a computer provided in a reproducing apparatus for reproducing data recorded on a recording medium while generating a tracking signal for performing tracking control which uses a DPD (Differential Phase Detection) method, the reproducing apparatus provided with: a reading device for reading reflected light of a laser beam applied onto the recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; a generating device for performing a phase comparison process on the equalization-corrected signal, thereby generating the tracking signal; and a reproducing device for reproducing the data recorded on the recording medium while performing the tracking control on the basis of the generated tracking signal, the computer program making the computer function as at least one portion of the reading device, the amplitude-limiting device, the filtering device, the generating device, and the reproducing device.

The operation and other advantages of the present invention will become more apparent from the embodiments explained below.

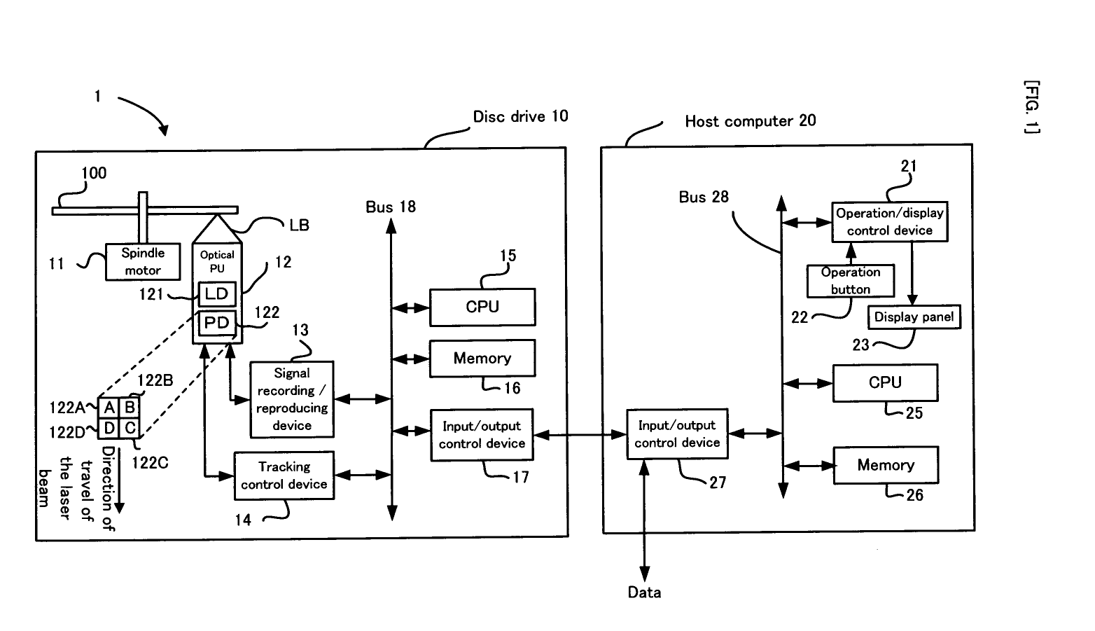

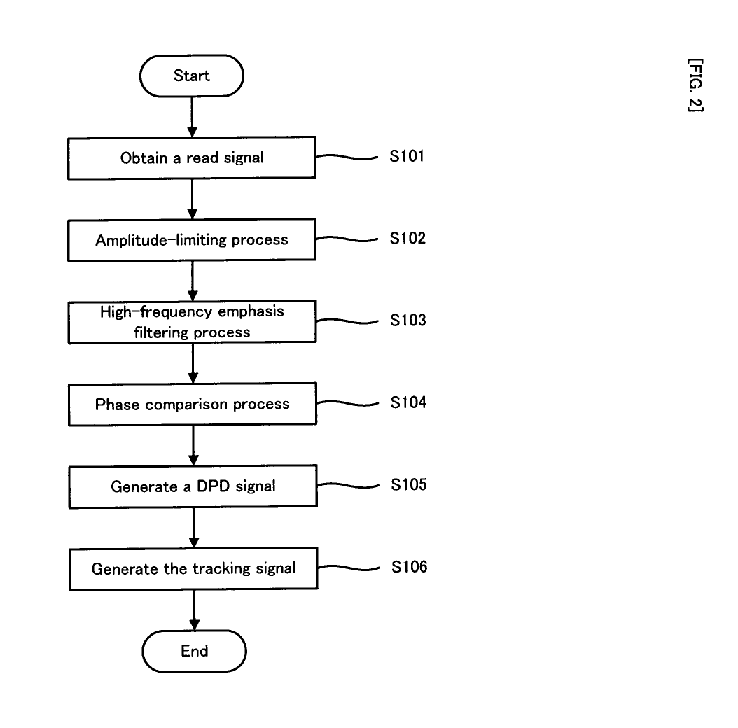

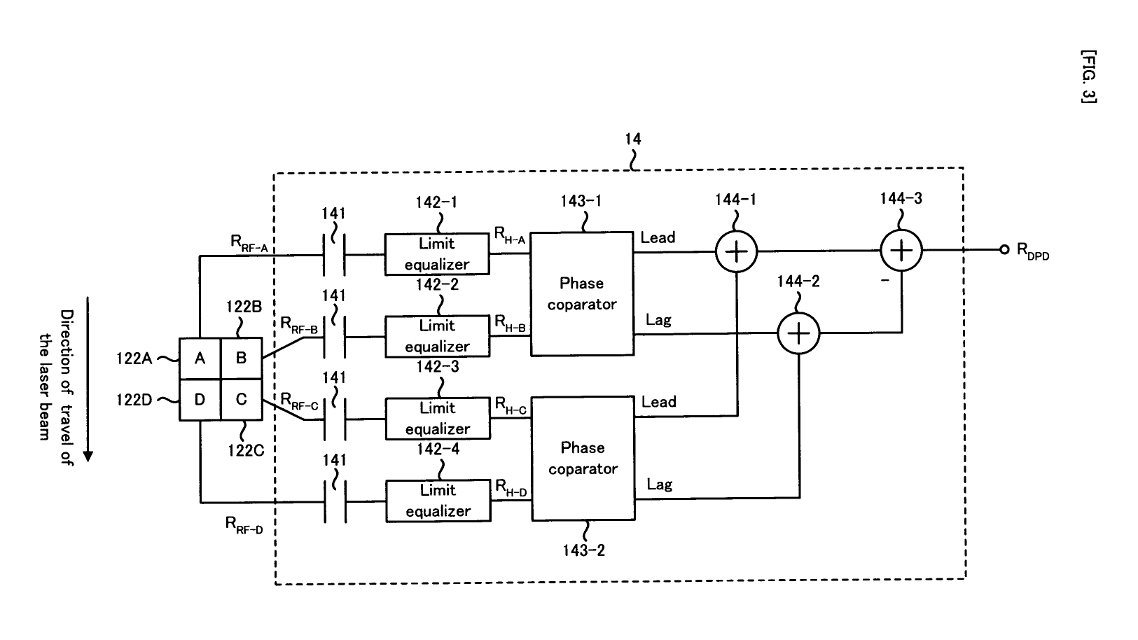

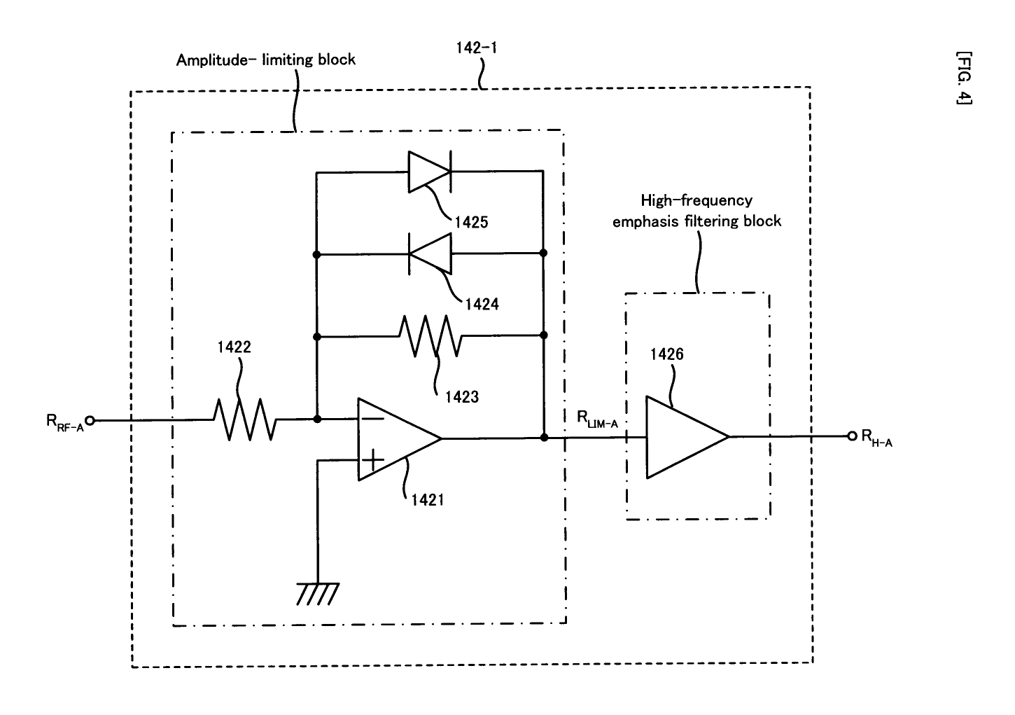

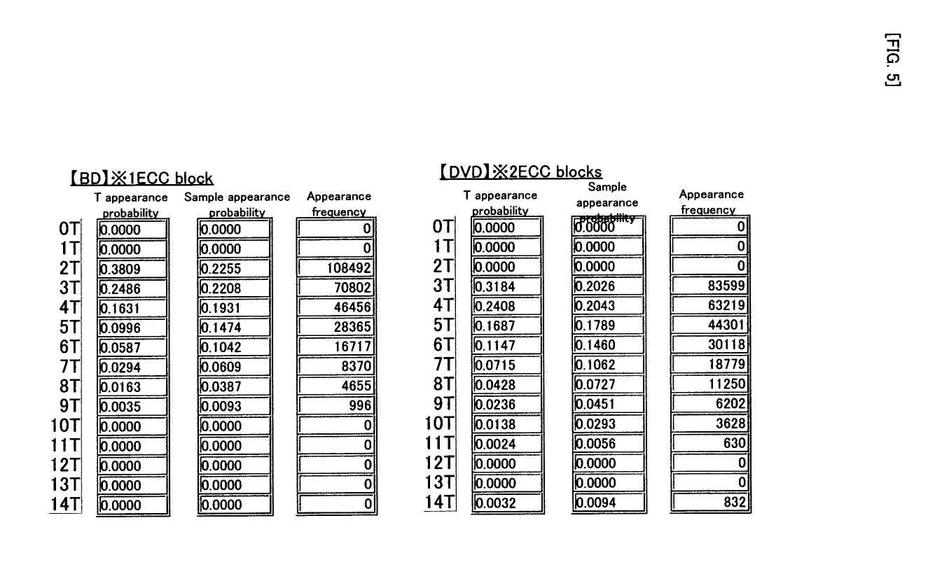

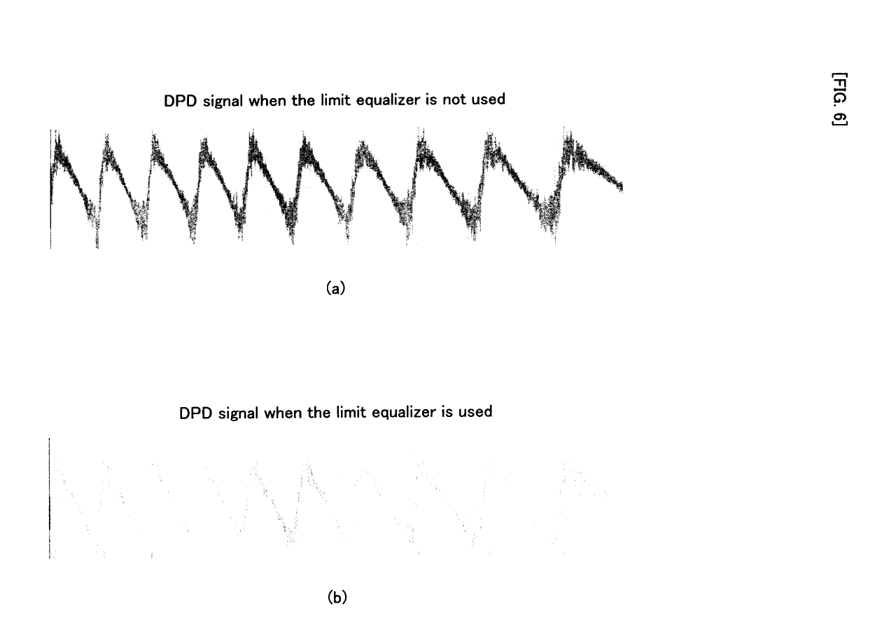

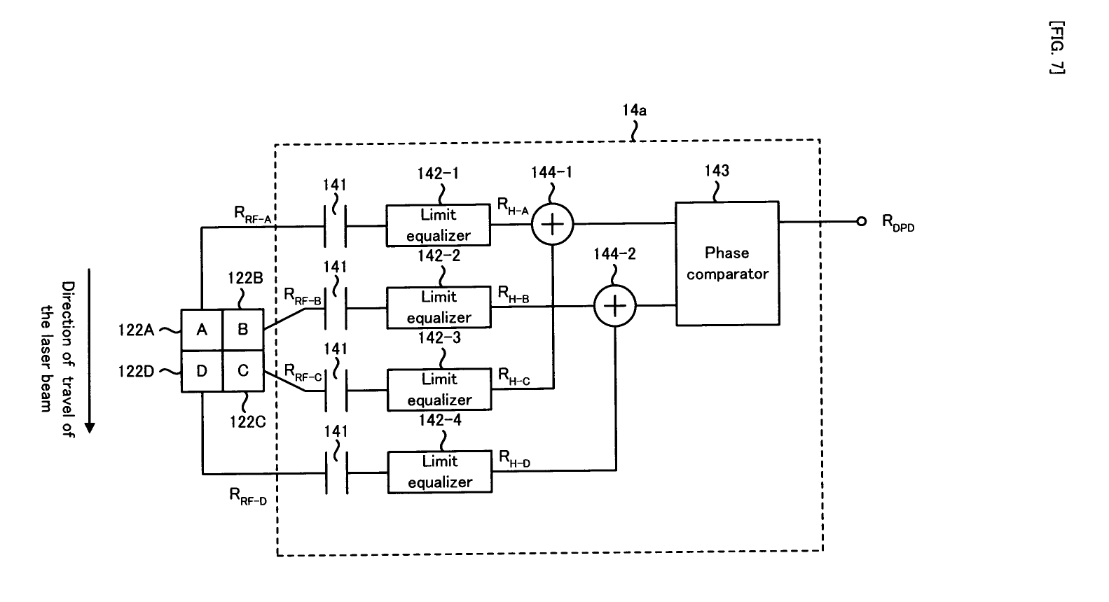

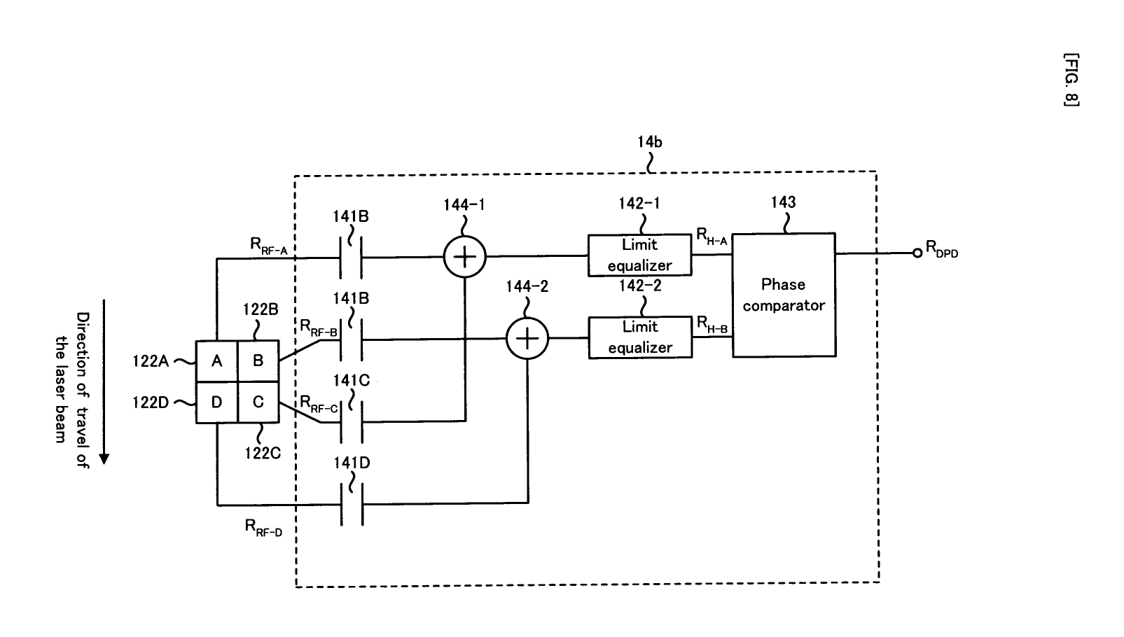

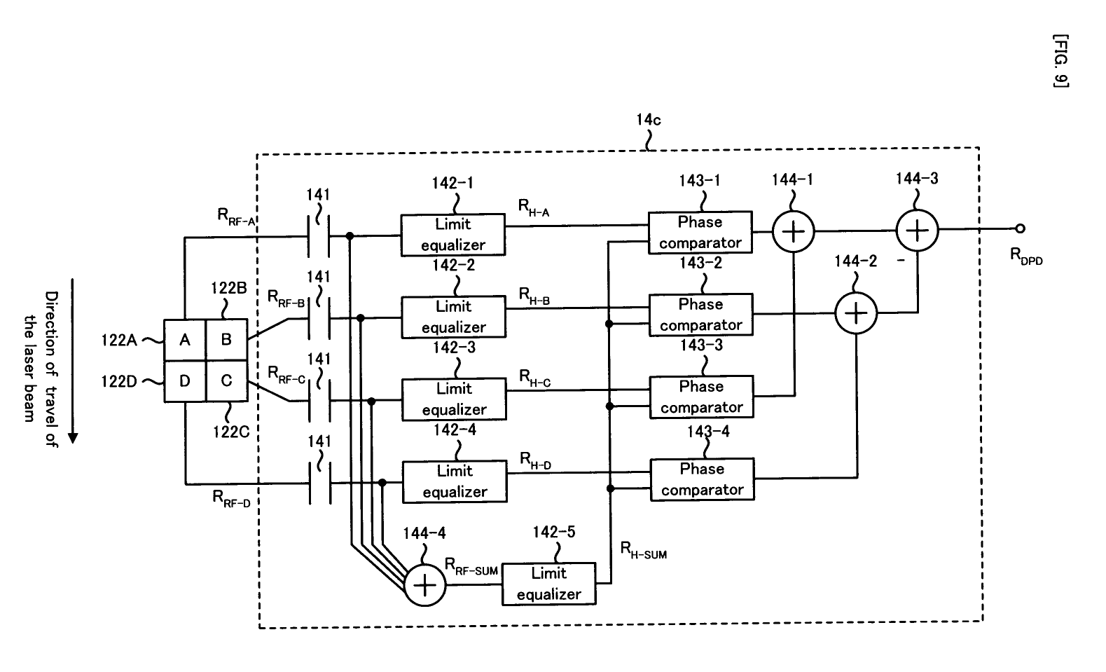

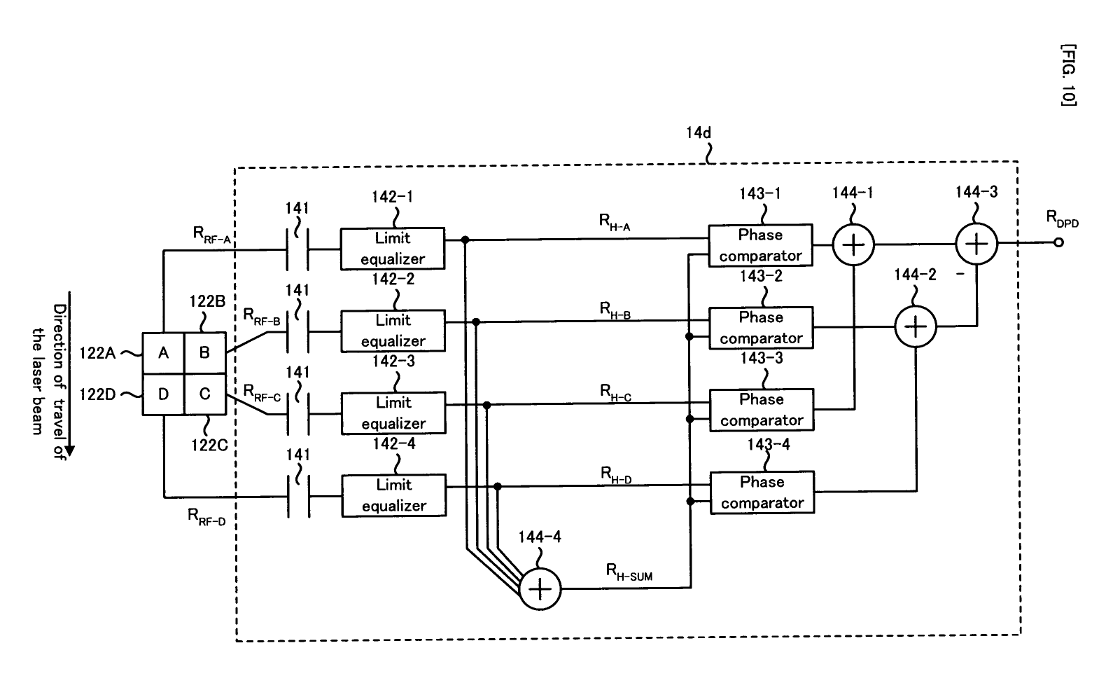

### BRIEF DESCRIPTION OF DRAWINGS

[FIG. 1] FIG. 1 is a block diagram conceptually showing the basic structure of an information recording/reproducing apparatus in a first example.

[FIG. 2] FIG. 2 is a flowchart conceptually showing a flow of a specific example of an operation of generating a tracking signal in the information recording/reproducing apparatus in the first example.

[FIG. 3] FIG. 3 is a block diagram conceptually showing a first structure example of a tracking control device.

[FIG. 4] FIG. 4 is a block diagram conceptually showing the basic structure of a limit equalizer.

[FIG. 5] FIG. 5 is a table showing the probability of appearance of a data pattern with each run length.

[FIG. 6] FIG. 6 are graphs conceptually showing waveforms of a DPD signal generated by using the limit equalizer as in the information recording/reproducing apparatus in the first example and a DPD signal generated without using the limit equalizer (i.e. by using a normal simple equalizer).

[FIG. 7] FIG. 7 is a block diagram conceptually showing a second structure example of the tracking control device.

[FIG. 8] FIG. 8 is a block diagram conceptually showing a third structure example of the tracking control device.

[FIG. 9] FIG. 9 is a block diagram conceptually showing a fourth structure example of the tracking control device.

[FIG. 10] FIG. 10 is a block diagram conceptually showing a fifth structure example of the tracking control device.

### DESCRIPTION OF REFERENCE CODES

1 information recording/reproducing apparatus
10 disc drive
20 host computer
12 optical pickup
121 laser diode
122 photodetector
13 signal recording/reproducing device
14 tracking control device
142 limit equalizer
143 phase comparator
144 adder

### BEST MODE FOR CARRYING OUT THE INVENTION

Hereinafter, as the best mode for carrying out the present invention, an explanation will be given on embodiments of the tracking signal generating apparatus and method, the reproducing apparatus and method, and the computer program of the present invention.

(Embodiment of Tracking Signal Generating Apparatus)

An embodiment of the tracking signal generating apparatus of the present invention is a tracking signal generating apparatus for generating a tracking signal for performing tracking control which uses a DPD (Differential Phase Detection) method, the tracking signal generating apparatus provided with: a reading device for reading reflected light of a laser beam applied onto a recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; and a generating device for performing a phase comparison process on the equalization-corrected signal, thereby generating the tracking signal.

According to the embodiment of the tracking signal generating apparatus of the present invention, the tracking signal is generated on the basis of the comparison result of the phase of the read signal (i.e. the result of the phase comparison process). In other words, the DPD method is used to generate the tracking signal.

In particular, in the tracking signal generating apparatus in the embodiment, before the phase comparison process is performed on the read signal, the amplitude-limiting process is performed on the read signal by the operation of the amplitude-limiting device. In other words, the amplitude limit level of the read signal is limited. Specifically, in a signal component of the read signal whose amplitude level is greater than the upper limit or less than the lower limit of the amplitude limit value, the amplitude level is limited to the upper limit or lower limit of the amplitude limit value. On the other hand, in a signal component of the read signal whose amplitude level is less than or equal to the upper limit or greater than or equal to the lower limit of the amplitude limit value, the amplitude level is not limited. The read signal in which the amplitude level is limited in this manner is referred to as the amplitude limit signal. Then, moreover, by the operation of the filtering device, the filtering process (more specifically, the high-frequency emphasis filtering process) is performed on the amplitude limit signal. As a result, the equalization-corrected signal is obtained in which the amplitude level of the signal component of a data pattern with a relatively short run length (e.g. a data pattern with a run length of 3 T or the like if the recording medium is a DVD, and a data pattern with a run length of 2 T or the like if the recording medium is a Blu-ray Disc) included in the read signal is emphasized. In other words, the amplitude-limiting device and the filtering device perform the same operation as that of a so-called limit equalizer, on the read signal.

Then, the tracking signal is generated on the basis of the comparison result of the phase of the read signal on which the amplitude-limiting process and the high-frequency emphasis filtering process are performed (i.e. the equalization-corrected signal).

As described above, in the embodiment, the high-frequency emphasis filtering process is performed after the amplitude-limiting process is performed on the read signal, so that it is possible to perform the high-frequency emphasis of the read signal without increasing an influence of intersymbol interference. In other words, it is possible to perform the high-frequency emphasis of the read signal while the signal component of the data pattern with the relatively short run length is not hidden in a noise component. Moreover, the comparison in phase of the equalization-corrected signal allows the tracking signal to be generated, so that the tracking signal can be generated by effectively using the signal component of the data pattern with the relatively short run length.

If the high-frequency emphasis is performed on the read signal without the amplitude-limiting process (i.e. if the amplitude-limiting device is not provided), the influence of intersymbol interference will likely increase, resulting in reduced accuracy of the generated tracking signal. In order to avoid such a disadvantage, in the method disclosed in the patent document 1 described above, the signal component of the data pattern with the relatively short run length is removed. However, the data pattern with the relatively short run length has a relatively high probability of appearance. Thus, as in the tracking signal generating apparatus in the embodiment, by effectively using the signal component of the data pattern with the relatively short run length (i.e. not by removing but using it), it is possible to generate the tracking signal in which the accuracy is further improved (in other words, of high quality).

As explained above, according to the tracking signal generating apparatus in the embodiment, it is possible to generate the tracking signal in which the accuracy is further improved, without increasing the influence of intersymbol interference and without removing the signal component of the data pattern with the relatively short run length (i.e. by effectively using the signal component of the data pattern with the relatively short run length) when performing the tracking control using, for example, the DPD method.

In one aspect of the tracking signal generating apparatus of the present invention, the reading device receives the reflected light in four light-receiving areas obtained by performing division in a direction of travel of the laser beam and in a direction of crossing the direction of travel of the laser beam, thereby obtaining four read signals, and the amplitude-limiting device limits an amplitude level of each of the four read signals or a signal which is obtained by performing a predetermined arithmetic process (e.g. an addition process or the like) on the four read signals, by the amplitude limit value, thereby obtaining the amplitude limit signal.

According to this aspect, it is possible to preferably generate the tracking signal by using the DPD method while receiving the aforementioned various effects.

In an aspect of the tracking signal generating apparatus in which the reflected light is received in the four light-receiving areas to obtain the four read signals, the amplitude-limiting device may limit an amplitude level of each of the four read signals by the amplitude limit value, thereby obtaining four amplitude limit signals, the filtering device may perform the high-frequency emphasis filtering process on each of the four amplitude limit signals, thereby obtaining four equalization-corrected signals, and the generating device may use a direct method as the phase comparison process to generate the tracking signal, the direct method (i) comparing phases of two equalization-corrected signals corresponding to two light-receiving areas of the four light-receiving areas located on a forward side of the direction of travel of the laser beam and (ii) comparing phases of two equalization-corrected signals corresponding to two light-receiving areas of the four light-receiving areas located on an opposite side of the direction of travel of the laser beam.

By virtue of such construction, it is possible to preferably generate the tracking signal by using the so-called DPD direct method while receiving the aforementioned various effects.

In an aspect of the tracking signal generating apparatus in which the reflected light is received in the four light-receiving areas to obtain the four read signals, the amplitude-limiting device may limit an amplitude level of each of the four read signals by the amplitude limit value, thereby obtaining four amplitude limit signals, the filtering device may perform the high-frequency emphasis filtering process on each of the four amplitude limit signals, thereby obtaining four equalization-corrected signals, and the generating device may use a pure method as the phase comparison process to generate the tracking signal, the pure method comparing (i) a phase of a signal obtained by adding two equalization-corrected signals corresponding to two light-receiving areas of the four light-receiving areas located at first diagonal positions and (ii) a phase of a signal obtained by adding two equalization-corrected signals corresponding to two light-receiving areas of the four light-receiving areas located at second diagonal positions.

By virtue of such construction, it is possible to preferably generate the tracking signal by using the so-called DPD pure method while receiving the aforementioned various effects.

In an aspect of the tracking signal generating apparatus in which the reflected light is received in the four light-receiving areas to obtain the four read signals, the amplitude-limiting device may limit an amplitude level of each of a signal obtained by adding two read signals corresponding to two light-receiving areas of the four light-receiving areas located at first diagonal positions and a signal obtained by adding two read signals corresponding to two light-receiving areas of the four light-receiving areas located at second diagonal positions, by the amplitude limit value, thereby obtaining two amplitude limit signals, the filtering device may perform the high-frequency emphasis filtering process on each of the two amplitude limit signals, thereby obtaining two equalization-corrected signals, and the generating device may use a pure method of comparing phases of the two equalization-corrected signals, as the phase comparison process to generate the tracking signal.

By virtue of such construction, it is possible to preferably generate the tracking signal by using the so-called DPD pure method while receiving the aforementioned various effects.

In an aspect of the tracking signal generating apparatus in which the reflected light is received in the four light-receiving areas to obtain the four read signals, the amplitude-limiting device may limit amplitude levels of the four read signals and a signal which is obtained by adding the four read signals, by the amplitude limit value, thereby obtaining five amplitude limit signals, the filtering device may perform the high-frequency emphasis filtering process on the five amplitude limit signals, thereby obtaining five equalization-corrected signals, and the generating device may use a quad method of comparing (i) a phase of each of four of the five equalization-corrected signals corresponding to the four read signals and (ii) a phase of one of the five equalization-corrected signals corresponding to the signal obtained by adding the four read signals, to generate the tracking signal.

By virtue of such construction, it is possible to preferably generate the tracking signal by using the so-called DPD quad method while receiving the aforementioned various effects.

In an aspect of the tracking signal generating apparatus in which the reflected light is received in the four light-receiving areas to obtain the four read signals, the amplitude-limiting device may limit an amplitude level of each of the four read signals by the amplitude limit value, thereby obtaining four amplitude limit signals, the filtering device may perform the high-frequency emphasis filtering process on the four amplitude limit signals, thereby obtaining four equalization-corrected signals, and the generating device may use a quad method of comparing (i) a phase of each of the four equalization-corrected signals and (ii) a phase of a signal obtained by adding the four equalization-corrected signals, to generate the tracking signal.

By virtue of such construction, it is possible to preferably generate the tracking signal by using the so-called DPD quad method while receiving the aforementioned various effects.

(Embodiment of Tracking Signal Generating Method)

An embodiment of the tracking signal generating method of the present invention is a tracking signal generating method of generating a tracking signal for performing tracking control which uses a DPD (Differential Phase Detection) method, the tracking signal generating method provided with: a reading process of reading reflected light of a laser beam applied onto a recording medium, thereby obtaining a resulting read signal; an amplitude-limiting process of limiting an amplitude level of the read signal by a predetermined amplitude value, thereby obtaining an amplitude limit signal; a filtering process of performing a high-frequency emphasis filtering process on the amplitude limit signal, thereby obtaining an equalization-corrected signal; and a generating process of performing a phase comparison process on the equalization-corrected signal, thereby generating the tracking signal.

According to the embodiment of the tracking signal generating method of the present invention, it is possible to receive the same various effects as those received by the embodiment of the tracking signal generating apparatus of the present invention described above.

Incidentally, in response to the aforementioned various aspects in the embodiment of the tracking signal generating apparatus of the present invention, the embodiment of the tracking signal generating method of the present invention can also adopt various aspects.

(Embodiment of Reproducing Apparatus)

An embodiment of the reproducing apparatus of the present invention is a reproducing apparatus for reproducing data recorded on a recording medium while generating a tracking signal for performing tracking control which uses a DPD (Differential Phase Detection) method, the reproducing apparatus provided with: a reading device for reading reflected light of a laser beam applied onto the recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; a generating device for performing a phase comparison process on the equalization-corrected signal, thereby generating the tracking signal; and a reproducing device for reproducing the data recorded on the recording medium while performing the tracking control on the basis of the generated tracking signal.

According to the embodiment of the reproducing apparatus of the present invention, it is possible to reproduce the data recorded on the recording medium while receiving the same various effects as those received by the embodiment of the tracking signal generating apparatus of the present invention described above.

Incidentally, in response to the aforementioned various aspects in the embodiment of the tracking signal generating apparatus of the present invention, the embodiment of the reproducing apparatus of the present invention can also adopt various aspects.

(Embodiment of Reproducing Method)

An embodiment of the reproducing method of the present invention is a reproducing method of reproducing data recorded on a recording medium while generating a tracking signal for performing tracking control which uses a DPD (Differential Phase Detection) method, the reproducing method provided with: a reading process of reading reflected light of a laser beam applied onto the recording medium, thereby obtaining a resulting read signal; an amplitude-limiting process of limiting an amplitude level of the read signal by a predetermined amplitude value, thereby obtaining an amplitude limit signal; a filtering process of performing a high-frequency emphasis filtering process on the amplitude limit signal, thereby obtaining an equalization-corrected signal; a generating process of performing a phase comparison process on the equalization-corrected signal, thereby generating the tracking signal; and a reproducing process of reproducing the data recorded on the recording medium while performing the tracking control on the basis of the generated tracking signal.

According to the embodiment of the reproducing method of the present invention, it is possible to reproduce the data recorded on the recording medium while receiving the same various effects as those received by the embodiment of the tracking signal generating apparatus of the present invention described above.

Incidentally, in response to the aforementioned various aspects in the embodiment of the tracking signal generating apparatus of the present invention, the embodiment of the reproducing method of the present invention can also adopt various aspects.

(Embodiments of Computer Program)

A first embodiment of the computer program of the present invention is a computer program for controlling a computer provided in a tracking signal generating apparatus for generating a tracking signal for performing tracking control which uses a DPD (Differential Phase Detection) method, the tracking signal generating apparatus provided with: a reading device for reading reflected light of a laser beam applied onto a recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; and a generating device for performing a phase comparison process on the equalization-corrected signal, thereby generating the tracking signal (i.e. the embodiment of the tracking signal generating apparatus of the present invention described above (including its various aspects)), the computer program making the computer function as at least one portion of the reading device, the amplitude-limiting device, the filtering device, and the generating device.

According to the first embodiment of the computer program of the present invention, the aforementioned embodiment of the tracking signal generating apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the aforementioned embodiment of the tracking signal generating apparatus of the present invention, the first embodiment of the computer program of the present invention can also adopt various aspects.

A second embodiment of the computer program of the present invention is a computer program for controlling a computer provided in a reproducing apparatus for reproducing data recorded on a recording medium while generating a tracking signal for performing tracking control which uses a DPD (Differential Phase Detection) method, the reproducing apparatus provided with: a reading device for reading reflected light of a laser beam applied onto the recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; a generating device for performing a phase comparison process on the equalization-corrected signal, thereby generating the tracking signal; and a reproducing device for reproducing the data recorded on the recording medium while performing the tracking control on the basis of the generated tracking signal (i.e. the embodiment of the reproducing apparatus of the present invention described above (including its various aspects)), the computer program making the computer function as at least one portion of the reading device, the amplitude-limiting device, the filtering device, the generating device, and the reproducing device.

According to the second embodiment of the computer program of the present invention, the aforementioned embodiment of the reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the aforementioned embodiment of the tracking signal generating apparatus of the present invention, the second embodiment of the computer program of the present invention can also adopt various aspects.

(Embodiments of Computer Program Product)

A first embodiment of the computer program product of the present invention is a computer program product in a computer-readable medium for tangibly embodying a program of instructions executable by a computer provided in a tracking signal generating apparatus for generating a tracking signal for performing tracking control which uses a DPD (Differential Phase Detection) method, the tracking signal generating apparatus provided with: a reading device for reading reflected light of a laser beam applied onto a recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; and a generating device for performing a phase comparison process on the equalization-corrected signal, thereby generating the tracking signal (i.e. the embodiment of the tracking signal generating apparatus of the present invention described above (including its various aspects)), the computer program making the computer function as at least one portion of the reading device, the amplitude-limiting device, the filtering device, and the generating device.

According to the first embodiment of the computer program product of the present invention, the aforementioned embodiment of the tracking signal generating apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the tracking signal generating apparatus of the present invention.

Incidentally, in response to the various aspects in the aforementioned embodiment of the tracking signal generating apparatus of the present invention, the first embodiment of the computer program product of the present invention can also employ various aspects.

A second embodiment of the computer program product of the present invention is a computer program product in a computer-readable medium for tangibly embodying a program of instructions executable by a computer provided in a reproducing apparatus for reproducing data recorded on a recording medium while generating a tracking signal for performing tracking control which uses a DPD (Differential Phase Detection) method, the reproducing apparatus provided with: a reading device for reading reflected light of a laser beam applied onto the recording medium, thereby obtaining a resulting read signal; an amplitude-limiting device for limiting an amplitude level of the read signal by a predetermined amplitude value, thereby obtaining an amplitude limit signal; a filtering device for performing a high-frequency emphasis filtering process on the amplitude limit signal, thereby obtaining an equalization-corrected signal; a generating device for performing a phase comparison process on the equalization-corrected signal, thereby generating the tracking signal; and a reproducing device for reproducing the data recorded on the recording medium while performing the tracking control on the basis of the generated tracking signal (i.e. the embodiment of the reproducing apparatus of the present invention described above (including its various aspects)), the computer program making the computer function as at least one portion of the reading device, the amplitude-limiting device, the filtering device, the generating device, and the reproducing device.

According to the second embodiment of the computer program product of the present invention, the aforementioned embodiment of the reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned embodiment of the reproducing apparatus of the present invention.

Incidentally, in response to the various aspects in the aforementioned embodiment of the tracking signal generating apparatus of the present invention, the second embodiment of the computer program product of the present invention can also employ various aspects.

The operation and other advantages of the present invention will become more apparent from the example explained below.

As explained above, according to the embodiment of the tracking signal generating apparatus of the present invention, it is provided with the reading device, the amplitude-limiting device, the filtering device, and the generating device. According to the embodiment of the tracking signal generating method of the present invention, it is provided with the reading process, the amplitude-limiting process, the filtering process, and the generating process. According to the embodiment of the reproducing apparatus of the present invention, it is provided with the reading device, the amplitude-limiting device, the filtering device, the generating device, and the reproducing device. According to the embodiment of the reproducing method of the present invention, it is provided with the reading process, the amplitude-limiting process, the filtering process, the generating process, and the reproducing device. According to each embodiment of the computer program of the present invention, it makes a computer function as the embodiment of the tracking signal generating apparatus, recording apparatus, or reproducing apparatus of the present invention. Therefore, it is possible to further improve the accuracy of the tracking signal when performing the tracking control using, for example, the DPD method.

### Example

Hereinafter, the example of the present invention will be explained on the basis of the drawings. Incidentally, the following example gives an explanation by using an information recording/reproducing apparatus which is provided with the tracking signal generating apparatus of the present invention.

(1) Basic Structure

Firstly, with reference to FIG. 1, the basic structure of an information recording/reproducing apparatus 1 in the example will be described. FIG. 1 is a block diagram conceptually showing the basic structure of the information recording/reproducing apparatus 1 in the example. Incidentally, the information recording/reproducing apparatus 1 has a function of recording data onto an optical disc 100 and a function of reproducing the data recorded on the optical disc 100.

As shown in FIG. 1, the information recording/reproducing apparatus 1 is provided with a disc drive 10 on which the optical disc 100 is actually loaded and on which data recording and data reproduction are performed; and a host computer 20, such as a personal computer, for controlling the data recording and reproduction with respect to the disc drive 10.

The disc drive 10 is provided with the optical disc 100, a spindle motor 11, an optical pickup (PU) 12, a signal recording/reproducing device 13, a tracking control device 14, a CPU 15, a memory 16, an input/output control device 17, and a bus 18. Moreover, the host computer 200 is provided with an operation/display control device 21, an operation button 22, a display panel 23, a CPU 25, a memory 26, an input/output control device 27, and a bus 28.

The spindle motor 11 is to rotate and stop the optical disc 100, and it operates when accessing the optical disc 10. More specifically, the spindle motor 11 is constructed to rotate the optical disc 100 at a predetermined speed and stop it, under the spindle servo provided by a servo unit or the like not illustrated.

The optical pickup 12 is provided with a laser diode (LD) 121; a photodetector (PD) 122, which constitutes one specific example of the “reading device” of the present invention; a collimator lens and an objective lens, which are not illustrated; and the like, in order to perform the recording/reproduction on the optical disc 100. More specifically, upon the data recording, the laser diode 121 irradiates the optical disc 100 with a laser beam LB with a predetermined recording power with it modulated. As a result, a data pattern according to the data is formed on the recording surface of the optical disc 100. On the other hand, upon the data reproduction, the laser diode 121 irradiates the optical disc 100 with the laser beam LB with a predetermined reproduction power. The irradiated laser beam LB is reflected on the recording surface of the optical disc 100. The reflected light is received on the photodetector 122, by which the data is reproduced.

Incidentally, the photodetector 122 is a four-division photodetector in which its light-receiving area is divided in a direction of travel of the laser beam LB (in other words, the rotational direction of the optical disc 100) and in a direction substantially perpendicular to the direction of travel of the laser beam LB (in other words, the radial direction of the optical disc and the direction of the tracking). More specifically, the photodetector 122 is provided with a division photodetector 122A, a division photodetector 122B, a division photodetector 122C, and a division photodetector 122D.

The signal recording/reproducing device 13 controls the spindle motor 11 and the optical pickup 12 under the control of the CPU 15, thereby performing the recording/reproducing on the optical disc 100. More specifically, the signal recording/reproducing device 13 is provided with a laser diode driver (LD driver), a head amplifier, and the like. The laser diode driver, for example, generates a drive signal and drives the laser diode 121 built in the optical pickup 12. The head amplifier amplifies the output signal of the photodetector 122 disposed in the optical pickup 12 (i.e. a signal indicating the reflected light of the laser beam and a read signal), and it outputs the amplified signal.

The tracking control device 14 performs tracking control of the optical pickup 12. More specifically, the tracking control device 14 generates a tracking signal (in other words, a tracking error signal) on the basis of the output signal of the photodetector 122. Moreover, the tracking control device 14 outputs the generated tracking signal to an actuator (not illustrated) for realizing the displacement of the optical pickup 12 in a tracking direction. As a result, the not-illustrated actuator displaces the optical pickup 12 in the tracking direction, on the basis of the tracking signal TE outputted from the tracking control device 14. In the example, the tracking control device 14 uses a DPD (Differential Phase Detection) method to generate the tracking signal. Incidentally, a specific operation of generating the tracking signal TE will be detailed later (refer to FIG. 2 or the like).

The CPU 15 is connected to the signal recording/reproducing device 13, the tracking control device, the memory 16, and the input/output control device 17 through the bus 18, and it controls the entire disc drive 10 by giving instructions to the signal recording/reproducing device 13, the tracking control device, the memory 16, and the input/output control device 17. Normally, software or firmware for operating the CPU 15 is stored in the memory 16.

The memory 16 is used in the general data processing on the disc drive 10, including a data buffer area used in a recording operation and a reproducing operation, an area used as an intermediate buffer when data is converted into the data that can be used on the signal recording/reproducing device 13, and the like. Moreover, the memory 16 is provided with a ROM area in which a program for performing the operations of the information recording/reproducing apparatus 1, i.e., firmware, is stored; a RAM area in which the data used in the recording operation and the reproducing operation is temporarily stored and in which a parameter or the like required for the operations of the firmware or the like is stored; and the like.

The input/output control device 17 controls the data input/output from the exterior with respect to the disc drive 10. A drive control command, which is issued from the external host computer 20 connected to the disc drive 10 via an interface, such as a SCSI (Small Computer System Interface) and an ATAPI (AT Attachment Packet Interface), is transmitted to the CPU 15 through the input/output control device 17. Moreover, the data used in the recording operation and the reproducing operation is also exchanged with the host computer 20 through the input/output control device 17.

The operation/display control device 21 performs the reception of the operation instruction and display with respect to the host computer 20. The operation/display control device 21 sends an instruction to perform the recording or reproduction, using the operation bottom 22, to the CPU 25. The CPU 25 sends a control command to the disc drive 10 through the input/output control device 27 on the basis of the instruction information from the operation/display control device 21, thereby controlling the entire disc drive 10. In the same manner, the CPU 25 can send a command of requiring the disc drive 10 to send the operational state to the host, to the disc drive 10. By this, it is possible to recognize the operational state of the disc drive 10, such as during recording and during reproduction. Thus, the CPU 25 can output the operational state of the disc drive 10, to the display panel 23, such as a fluorescent tube and a LCD, through the operation/display control device 21.

The memory 26 is an internal memory apparatus used by the host computer 20, and it is provided with, for example, a ROM area in which a firmware program such as BIOS (Basic Input/Output System) is stored; a RAM area in which a parameter required for the operation of an operating system, an application program, or the like is stored; and the like. Moreover, the memory 26 may be connected to an external memory apparatus, such as a hard disk not illustrated, through the input/output control device 27.

One specific example in which the disc drive 10 and the host computer 20, as explained above, are used together is household equipment, such as player equipment for reproducing video. The player equipment is equipment for outputting a video signal reproduced from the disc, to external display equipment, such as a television. The operation as the player equipment is performed by executing a program stored in the memory 26, on the CPU 25. Moreover, in another specific example, the disc drive 10 is a disc drive (hereinafter referred to as a drive, as occasion demands), and the host computer 20 is a personal computer or a workstation. The host computer 20, such as a personal computer, and the disc drive 10 are connected through the input/output control devices 17 and 27, such as the SCSI and the ATAPI. An application, such as software, which is installed in the host computer 20, controls the disc drive 10.

(2) Specific Example of Operation of Generating Tracking Signal

Next, with reference to FIG. 2, an explanation will be given on a specific example of an operation of generating the tracking signal TE on the information recording/reproducing apparatus 1 in the example. FIG. 2 is a flowchart conceptually showing a flow of the specific example of the operation of generating the tracking signal TE in the information recording/reproducing apparatus 1 in the example.

As shown in FIG. 2, firstly, a read signal R_{RF}, which is the output of the photodetector 122 provided for the optical pickup 12, is outputted to the tracking control device 14 (step S101).

Then, by the operation of the tracking control device 14, an amplitude-limiting process is performed on the read signal R_{RF} (step S102). In other words, the amplitude level of the read signal R_{RF} is limited by a predetermined amplitude limit value. Specifically, in a signal component of the read signal R_{RF} whose amplitude level is greater than the upper limit or less than the lower limit of the amplitude limit value, the amplitude level is limited to the upper limit or lower limit of the amplitude limit value. On the other hand, in a signal component of the read signal R_{RF} whose amplitude level is less than or equal to the upper limit or greater than or equal to the lower limit of the amplitude limit value, the amplitude level is not limited. By performing the amplitude-limiting process in this manner, an amplitude limit signal R_{LIM} is generated.

On the other hand, by the operation of the tracking control device 14, a high-frequency emphasis filtering process is performed on the amplitude limit signal R_{LIM} (step S103). The high-frequency emphasis filtering process herein is, for example, a process of increasing the signal level near a signal component corresponding to a data pattern with the shortest run length (e.g. a data pattern with a run length of 3 T if the optical disc 100 is a DVD, and a data pattern with a run length of 2 T if the optical disc 100 is a Blu-ray Disc) in the amplitude limit signal R_{LIM}. As a result, an equalization-corrected signal R_{H} is generated.

The, by the operation of the tracking control device 14, a phase comparison process is performed on the equalization-corrected signal R_{H} (step S104). As a result, a DPD signal R_{DPD} is generated (step S105).

Then, on the basis of the DPD signal R_{DPD}, the tracking signal TE is generated (step S106). For example, by removing a high-frequency signal component from the DPD signal, the tracking signal TE is generated. Then, on the basis of the tracking signal TE, the tracking control is actually performed.

(3) First Structure Example of Tracking Control Device

Next, with reference to FIG. 3, an explanation will be given on a first structure example of the tracking control device 14 which performs the operation of generating the tracking signal TE described above. FIG. 3 is a block diagram conceptually showing the first structure example of the tracking control device 14. Incidentally, the tracking control device 14 in the first structure example shown in FIG. 3 uses a DPD direct method of the DPD method to generate the tracking signal TE.

As shown in FIG. 3, the tracking control device 14 is provided with a condenser 141-1 and a limit equalizer 142-1, which correspond to the division photodetector 122A; a condenser 141-2 and a limit equalizer 142-2, which correspond to the division photodetector 122B; a condenser 141-3 and a limit equalizer 142-3, which correspond to the division photodetector 122C; a condenser 141-4 and a limit equalizer 142-4, which correspond to the division photodetector 122D; a phase comparator 143-1; a phase comparator 143-2; an adder 144-1; an adder 144-2; and an adder 144-3.

With respect to a read signal R_{RF-A} which is the output of the division photodetector 122A, a low-frequency signal component is removed on the corresponding condenser 141, and then, the amplitude-limiting process and the high-frequency emphasis filtering process are performed on the corresponding limit equalizer 142-1. A resulting equalization-corrected signal R_{H-A} is outputted to the phase comparator 143-1.

In the same manner, with respect to a read signal R_{RF-B} which is the output of the division photodetector 122B, a low-frequency signal component is removed on the corresponding condenser 141, and then, the amplitude-limiting process and the high-frequency emphasis filtering process are performed on the corresponding limit equalizer 142-2. A resulting equalization-corrected signal R_{H-B} is outputted to the phase comparator 143-1.

In the same manner, with respect to a read signal R_{RF-C} which is the output of the division photodetector 122C, a low-frequency signal component is removed on the corresponding condenser 141, and then, the amplitude-limiting process and the high-frequency emphasis filtering process are performed on the corresponding limit equalizer 142-3. A resulting equalization-corrected signal R_{H-C} is outputted to the phase comparator 143-2.

In the same manner, with respect to a read signal R_{RF-D} which is the output of the division photodetector 122D, a low-frequency signal component is removed on the corresponding condenser 141, and then, the amplitude-limiting process and the high-frequency emphasis filtering process are performed on the corresponding limit equalizer 142-4. A resulting equalization-corrected signal R_{H-D} is outputted to the phase comparator 143-2.

Now, with reference to FIG. 4, an explanation will be given on the basic structure of the limit equalizer 142-1. FIG. 4 is a block diagram conceptually showing the basic structure of the limit equalizer 142-1. Incidentally, FIG. 4 explains the basic structure of the limit equalizer 142-1; however, the limit equalizers 142-2, 142-3, and 142-4 have the same structure.

As shown in FIG. 4, the limit equalizer 142-1 is provided with an amplitude-limiting block, which has an operational amplifier 1421 in which the positive input terminal is earthed; a resistance 1422 whose one end is connected to the negative input terminal of the operational amplifier 1421 and whose other end is connected to a terminal at which the read signal is inputted; a resistance 1423 which is connected between the output terminal and the negative input terminal of the operational amplifier 1421; a diode 1424 which is connected between the output terminal and the negative input terminal of the operational amplifier 1421 and in which a direction from the output terminal to the negative input terminal is set to a forward direction; and a diode 1425 which is connected between the output terminal and the negative input terminal of the operational amplifier 1421 and in which a direction from the negative input terminal to the output terminal is set to the forward direction. Moreover, the limit equalizer 142-1 is provided with a high-frequency emphasis filtering block, which has a filter 1426 for performing the high-frequency emphasis filtering on the output of the amplitude-limiting block.

On the limit equalizer 142-1 having such a structure, the amplitude-limiting process is performed by the amplitude-limiting block on the read signal R_{RF-A}, and the high-frequency emphasis filtering process is performed by the high-frequency emphasis filtering block on an amplitude limit signal R_{LIM-1} which is the output of the amplitude-limiting block. As a result, the equalization-corrected signal R_{H-A} is outputted.

Incidentally, the explanation in FIG. 4 is about the limit equalizer 142-1 which processes an analog signal. However, of course, a limit equalizer 142 which processes a digital signal may be used. In particular, regarding the details of the limit equalizer that processes the digital signal, please refer to Japanese Patent No. 3459563. However, it is preferable to use the limit equalizer 142-1 which processes an analog signal from the view point of an easy circuit structure.

In FIG. 3 again, on the phase comparator 143-1, the phase of the equalization-corrected signal R_{H-A} which is the output of the limit equalizer 142-1 is compared with the phase of the equalization-corrected signal R_{H-B} which is the output of the limit equalizer 142-2. In other words, the phase of the equalization-corrected signal R_{H-A} and the phase of the equalization-corrected signal R_{H-B}, which correspond to the division photodetectors 122A and 122B of the four division photodetectors located on the opposite side (i.e. following side) of the direction of travel of the laser beam LB, are compared.

In the same manner, on the phase comparator 143-2, the phase of the equalization-corrected signal R_{H-C} which is the output of the limit equalizer 142-3 is compared with the phase of the equalization-corrected signal R_{H-D} which is the output of the limit equalizer 142-4. In other words, the phase of the equalization-corrected signal R_{H-C} and the phase of the equalization-corrected signal R_{H-C}, which correspond to the division photodetectors 122C and 122D of the four division photodetectors located on the side (i.e. leading side) of the direction of travel of the laser beam LB, respectively, are compared.

Then, on the adder 144-1, the phase comparison result on the lead side of the phase comparator 143-1 and the phase comparison result on the lead side of the phase comparator 143-2 are added. In the same manner, on the adder 144-2, the phase comparison result on the lag side of the phase comparator 143-1 and the phase comparison result on the lag side of the phase comparator 143-2 are added.

Then, on the adder 144-3, the added value of the phase comparison results on the lag side of the phase comparators 143-1 and 143-2 is subtracted from the added value of the phase comparison results on the lead side of the phase comparators 143-1 and 143-2, by which the DPD signal R_{DPD} is generated.

Incidentally, the limit equalizers 142-1, 142-2, 142-3, and 142-4 constitute one specific example of the “amplitude-limiting device” and the “filtering device” of the present invention. Moreover, the phase comparators 143-1 and 143-2, and the adders 144-1, 144-2, and 144-3 constitute one specific example of the “generating device” of the present invention.

As described above, in the example, the amplitude-limiting process is performed on the read signal R_{RF} before the high-frequency emphasis filtering process, so that it is possible to perform the high-frequency emphasis of the read signal R_{RF} without increasing an influence of intersymbol interference. In other words, it is possible to perform the high-frequency emphasis of the read signal R_{RF} without hiding the signal component of the data pattern with the relatively short run length in a noise component. Moreover, the comparison in phase of the equalization-corrected signal R_{H}, which results from the high-frequency emphasis, allows the DPD signal R_{DPD} (moreover, the tracking signal TE) to be generated, so that the tracking signal TE can be generated by effectively using the signal component of the data pattern with the relatively short run length.

If the high-frequency emphasis filtering process is performed on the read signal R_{RF} without the amplitude-limiting process (i.e. if a normal simple equalizer is used, instead of the limit equalizer 142), the influence of intersymbol interference will likely increase, resulting in reduced accuracy of the generated tracking signal TE. In order to avoid such a disadvantage, in the method disclosed in the patent document 1 described above, the signal component of the data pattern with the relatively short run length is removed. However, it is generally known that the data pattern with the relatively short run length has a relatively high probability of appearance.

Now, with reference to FIG. 5, an explanation will be given on the probability of appearance of a data pattern with each run length. FIG. 5 is a table showing the probability of appearance of a data pattern with each run length. Incidentally, FIG. 5 shows the appearance of probability in the DVD which adopts data patterns with run lengths of 3 T to 11 T and 14 T and in the Blu-ray Disc which adopts data patterns with run lengths of 2 T to 9 T, as one specific example of the optical disc 100.

FIG. 5 shows the probability of appearance (T appearance probability) without consideration of the run length, of the data pattern with each run length in 1ECC block, in a case where random data is recorded onto the Blu-ray Disc as one specific example of the optical disc 100. As shown in FIG. 5, in 1ECC block, the probability of appearance of the data pattern with a run length of 2 T is about 38%, the probability of appearance of the data pattern with a run length of 3 T is about 25%, the probability of appearance of the data pattern with a run length of 4 T is about 16%, the probability of appearance of the data pattern with a run length of 5 T is about 10%, the probability of appearance of the data pattern with a run length of 6 T is about 6%, the probability of appearance of the data pattern with a run length of 7 T is about 3%, the probability of appearance of the data pattern with a run length of 8 T is about 1.6%, and the probability of appearance of the data pattern with a run length of 9 T is about 0.35%.

Moreover, FIG. 5 shows the probability of appearance (sample appearance probability) with consideration of the run length, of the data pattern with each run length in 1ECC block, in the case where the random data is recorded onto the Blu-ray Disc as one specific example of the optical disc 100. As shown in FIG. 5, in 1ECC block, the probability of appearance of the data pattern with a run length of 2 T is about 23%, the probability of appearance of the data pattern with a run length of 3 T is about 22%, the probability of appearance of the data pattern with a run length of 4 T is about 19%, the probability of appearance of the data pattern with a run length of 5 T is about 15%, the probability of appearance of the data pattern with a run length of 6 T is about 10%, the probability of appearance of the data pattern with a run length of 7 T is about 6%, the probability of appearance of the data pattern with a run length of 8 T is about 3.9%, and the probability of appearance of the data pattern with a run length of 9 T is about 0.93%.

Incidentally, the probability of appearance without consideration of the run length is the probability of appearance in which weighting in the calculation of the probability of appearance of the data pattern with each run length is the same in each run length. In other words, it indicates the probability of appearance in a case where the number of times of appearance is counted as one when one data pattern with a certain run length occurs. On the other hand, the probability of appearance with consideration of the run length is the probability of appearance in which the weighting in the calculation of the probability of appearance of the data pattern with each run length depends on the run length. In other words, it indicates the probability of appearance in a case where the number of times of appearance is counted in accordance with the run length when one data pattern with a certain run length occurs.

Moreover, FIG. 5 shows the probability of appearance without consideration of the run length, of the data pattern with each run length in 1ECC block, in a case where random data is recorded onto the DVD as one specific example of the optical disc 100. As shown in FIG. 5, in 1ECC block, the probability of appearance of the data pattern with a run length of 3 T is about 32%, the probability of appearance of the data pattern with a run length of 4 T is about 24%, the probability of appearance of the data pattern with a run length of 5 T is about 17%, the probability of appearance of the data pattern with a run length of 6 T is about 11.5%, the probability of appearance of the data pattern with a run length of 7 T is about 7%, the probability of appearance of the data pattern with a run length of 8 T is about 4%, the probability of appearance of the data pattern with a run length of 9 T is about 2%, the probability of appearance of the data pattern with a run length of 10 T is about 1.3%, the probability of appearance of the data pattern with a run length of 11 T is about 0.24%, and the probability of appearance of the data pattern with a run length of 14 T is about 0.3%.

Moreover, FIG. 5 shows the probability of appearance (sample appearance probability) with consideration of the run length, of the data pattern with each run length in 1ECC block in the case where the random data is recorded onto the DVD as one specific example of the optical disc 100. As shown in FIG. 5, in 1ECC block, the probability of appearance of the data pattern with a run length of 3 T is about 20%, the probability of appearance of the data pattern with a run length of 4 T is about 20%, the probability of appearance of the data pattern with a run length of 5 T is about 18%, the probability of appearance of the data pattern with a run length of 6 T is about 15%, the probability of appearance of the data pattern with a run length of 7 T is about 11%, the probability of appearance of the data pattern with a run length of 8 T is about 7.3%, the probability of appearance of the data pattern with a run length of 9 T is about 4.5%, the probability of appearance of the data pattern with a run length of 10 T is about 2.9%, the probability of appearance of the data pattern with a run length of 11 T is about 0.56%, and the probability of appearance of the data pattern with a run length of 14 T is about 0.94%.

As described above, since the probability of appearance of the data pattern with the relatively short run length is relatively high, even if the signal components of the data pattern with the relatively short run length are uniformly removed to generate the tracking signal TE, the accuracy will be not necessarily optimal. However, in the example, by effectively using the signal component of the data pattern with the relatively short run length (i.e. not by removing it but by using it), it is possible to generate the tracking signal TE in which the accuracy is further improved (in other words, of high quality).

Now, with reference to FIG. 6, an explanation will be given on the waveforms of the DPD signal R_{DPD} generated by using the limit equalizer 142 as in the information recording/reproducing apparatus 1 in the example and the DPD signal R_{DPD} generated without using the limit equalizer 142 (i.e. by using the normal simple equalizer). FIG. 6 are graphs conceptually showing the waveforms of the DPD signal R_{DPD} generated by using the limit equalizer 142 as in the information recording/reproducing apparatus 1 in the example and the DPD signal R_{DPD} generated without using the limit equalizer 142 (i.e. by using the normal simple equalizer).

As shown in FIG. 6(a), in the DPD signal R_{DPD} generated without using the limit equalizer 142, it is seen that a noise component caused by the signal component of the data pattern with the relatively short run length is superimposed and that the influence of intersymbol interference increases. Thus, it is found that the quality of the DPD signal R_{DPD} is deteriorated.

On the other hand, as shown in FIG. 6(b), in the DPD signal R_{DPD} generated by using the limit equalizer 142, the noise component caused by the signal component of the data pattern with the relatively short run length is prevented from being superimposed. In other words, it is found that the DPD signal R_{DPD} is generated without increasing the influence of intersymbol interference. Moreover, not only the noise component caused by the signal component of the data pattern with the relatively short run length is prevented from being superimposed, but also the DPD signal R_{DPD} is generated by effectively using the signal component of the data pattern with the relatively short run length. Thus, it is possible to generate the DPD signal R_{DPD} (moreover, the tracking signal TE) in which the accuracy is further improved.

As explained above, according to the information recording/reproducing apparatus 1 in the example, it is possible to generate the tracking signal TE in which the accuracy is further improved, without increasing the influence of intersymbol interference and without removing the signal component of the data pattern with the relatively short run length (i.e. by effectively using the signal component of the data pattern with the relatively short run length) when performing the tracking control using, for example, the DPD method. As a result, the recording operation and the reproducing operation can be performed while the tracking control is performed preferably (in other words, accurately).

Incidentally, the above explains the structure that the tracking signal TE is generated by using the DPD direct method; however, of course, the other DPD methods may be used to generate the tracking signal TE. Hereinafter, other specific examples will be explained.

(4) Second Structure Example of Tracking Control Device

Next, with reference to FIG. 7, an explanation will be given on a second structure example of the tracking control device 14 which performs the operation of generating the tracking signal TE described above. FIG. 7 is a block diagram conceptually showing the second structure example of the tracking control device 14. Incidentally, a tracking control device 14a in the second structure example shown in FIG. 7 uses a DPD pure method of the DPD method to generate the tracking signal TE. Moreover, the same constituents as those of the tracking control device 14 in the first structure example described above will carry the same numerical references, and the detailed explanation thereof will be omitted.

As shown in FIG. 7, the tracking control device 14a in the second structure example is provided with a condenser 141-1 and a limit equalizer 142-1, which correspond to the division photodetector 122A; a condenser 141-2 and a limit equalizer 142-2, which correspond to the division photodetector 122B; a condenser 141-3 and a limit equalizer 142-3, which correspond to the division photodetector 122C; a condenser 141-4 and a limit equalizer 142-4, which correspond to the division photodetector 122D; a phase comparator 143; an adder 144-1; and an adder 144-2.

Even in the tracking control device 14a in the second structure example, as in the tracking control device 14 in the first structure example, an equalization-corrected signal R_{H-A} is generated on the limit equalizer 142-1. In the same manner, an equalization-corrected signal R_{H-B} is generated on the limit equalizer 142-2. In the same manner, an equalization-corrected signal R_{H-C} is generated on the limit equalizer 142-3. In the same manner, an equalization-corrected signal R_{H-D} is generated on the limit equalizer 142-4.

Then, on the adder 144-1, the equalization-corrected signal R_{H-A} which is the output of the limit equalizer 142-1 and the equalization-corrected signal R_{H-C} which is the output of the limit equalizer 142-3 are added. In other words, the equalization-corrected signal R_{H-A} and the equalization-corrected signal R_{H-C} which correspond to the two division photodetectors (i.e. the division photodetectors 122A and 122C) located at diagonal positions of the four division photodetecotrs, respectively, are added.

In the same manner, on the adder 144-2, the equalization-corrected signal R_{H-B} which is the output of the limit equalizer 142-2 and the equalization-corrected signal R_{H-D} which is the output of the limit equalizer 142-4 are added. In other words, the equalization-corrected signal R_{H-B} and the equalization-corrected signal R_{H-D} which correspond to the two division photodetectors (i.e. the division photodetectors 122B and 122D) located at diagonal positions of the four division photodetecotrs, respectively, are added.

Then, on the phase comparator 143, the phase of a signal obtained by adding the equalization-corrected signal R_{H-A} and the equalization-corrected signal R_{H-C} is compared with the phase of a signal obtained by adding the equalization-corrected signal R_{H-B} and the equalization-corrected signal R_{H-D}. As a result, a DPD signal R_{DPD} is generated.

Even in the second structure example having such a structure, it is possible to receive the various effects that can be received in the first structure example.

(5) Third Structure Example of Tracking Control Device

Next, with reference to FIG. 8, an explanation will be given on a third structure example of the tracking control device 14 which performs the operation of generating the tracking signal TE described above. FIG. 8 is a block diagram conceptually showing the third structure example of the tracking control device 14. Incidentally, a tracking control device 14b in the third structure example shown in FIG. 8 uses the DPD pure method of the DPD method to generate the tracking signal TE. Moreover, the same constituents as those of the tracking control device 14a in the second structure example described above will carry the same numerical references, and the detailed explanation thereof will be omitted.

As shown in FIG. 8, the tracking control device 14b in the third structure example is provided with a condenser 141-1, which corresponds to the division photodetector 122A; a condenser 141-2, which corresponds to the division photodetector 122B; a condenser 141-3, which corresponds to the division photodetector 122C; a condenser 141-4, which corresponds to the division photodetector 122D; a limit equalizer 142-1; a limit equalizer 142-2; a phase comparator 143; an adder 144-1; and an adder 144-2.

In the tracking control device 14b in the third structure example, firstly, on the adder 144-1, a read signal R_{RF-A} and a read signal R_{RF-C} which correspond to the two division photodetectors (i.e. the division photodetectors 122A and 122C) located at diagonal positions of the four division photodetecotrs, respectively, are added. Then, a signal obtained by the addition is inputted to the limit equalizer 142-1, thereby generating an equalization-corrected signal R_{H-A}.

In the same manner, on the adder 144-2, a read signal R_{RF-B} and a read signal R_{RF-D} which correspond to the two division photodetectors (i.e. the division photodetectors 122B and 122D) located at diagonal positions of the four division photodetecotrs, respectively, are added. Then, a signal obtained by the addition is inputted to the limit equalizer 142-2, thereby generating an equalization-corrected signal R_{H-B}.

Then, on the phase comparator 143, the phase of the signal obtained by adding the equalization-corrected signal R_{H-A} and the equalization-corrected signal R_{H-C} is compared with the phase of the signal obtained by adding the equalization-corrected signal R_{H-B} and the equalization-corrected signal R_{H-D}. As a result, a DPD signal R_{DPD} is generated.

As described above, in the third structure example, the read signals R_{RF-A}, R_{RF-B}, R_{RF-C}, and R_{RF-D} are inputted to the limit equalizers 142-1 and 142-2 after the addition of the read signals R_{RF-A}, R_{RF-B}, R_{RF-C}, and R_{RF-D} is performed on the adders 144-1 and 144-2. In other words, in comparison with the second structure example in which the read signals R_{RF-A}, R_{RF-B}, R_{RF-C}, and R_{RF-D} are inputted to the limit equalizers 142-1 and 142-2 before the addition of the equalization-corrected signals R_{H-A}, R_{H-B}, R_{H-C}, and R_{H-D} is performed on the adders 144-1 and 144-2, the arrangement of the limit equalizers 142-1 and 142-2 and the adders 144-1 and 144-2 is opposite. Even in the third structure example having such a structure, it is possible to receive the various effects that can be received in the first structure example.

(6) Fourth Structure Example of Tracking Control Device

Next, with reference to FIG. 9, an explanation will be given on a fourth structure example of the tracking control device 14 which performs the operation of generating the tracking signal TE described above. FIG. 9 is a block diagram conceptually showing the fourth structure example of the tracking control device 14. Incidentally, a tracking control device 14c in the fourth structure example shown in FIG. 9 uses a DPD quad method of the DPD method to generate the tracking signal TE. Moreover, the same constituents as those of the tracking control device 14 in the first structure example described above will carry the same numerical references, and the detailed explanation thereof will be omitted.

As shown in FIG. 9, the tracking control device 14c in the fourth structure example is provided with a condenser 141-1 and a limit equalizer 142-1, which correspond to the division photodetector 122A; a condenser 141-2 and a limit equalizer 142-2, which correspond to the division photodetector 122B; a condenser 141-3 and a limit equalizer 142-3, which correspond to the division photodetector 122C; a condenser 141-4 and a limit equalizer 142-4, which correspond to the division photodetector 122D; a limit equalizer 142-5; a phase comparator 143-1; a phase comparator 143-2; a phase comparator 143-3; a phase comparator 143-4; an adder 144-1; an adder 144-2; an adder 144-3; and an adder 144-4.

Even in the tracking control device 14c in the fourth structure example, as in the tracking control device 14 in the first structure example, an equalization-corrected signal R_{H-A} is generated on the limit equalizer 142-1. In the same manner, an equalization-corrected signal R_{H-B} is generated on the limit equalizer 142-2. In the same manner, an equalization-corrected signal R_{H-C} is generated on the limit equalizer 142-3. In the same manner, an equalization-corrected signal R_{H-D} is generated on the limit equalizer 142-4.

Moreover, in parallel with the operations on the limit equalizers 142-1, 142-2, 142-3, and 142-4, read signals R_{RF-A}, R_{RF-B}, R_{RF-C}, and R_{RF-D} which correspond to the four division photodetectors (i.e. the division photodetectors 122A, 122B, 122C, and 122D), respectively, are added on the adder 144-4. Moreover, a signal R_{RF-SUM} obtained by adding the read signals R_{RF-A}, R_{RF-B}, R_{RF-C}, and R_{RF-D} is inputted to the limit equalizer 142-5, thereby generating an equalization-corrected signal R_{H-SUM}.

Then, on the comparator 143-1, the phase of the equalization-corrected signal R_{H-A} which is the output of the limit equalizer 142-1 is compared with the phase of the equalization-corrected signal R_{H-SUM} which is the output of the limit equalizer 142-5. In the same manner, on the comparator 143-2, the phase of the equalization-corrected signal R_{H-B} which is the output of the limit equalizer 142-2 is compared with the phase of the equalization-corrected signal R_{H-SUM} which is the output of the limit equalizer 142-5. Then, on the comparator 143-3, the phase of the equalization-corrected signal R_{H-C} which is the output of the limit equalizer 142-3 is compared with the phase of the equalization-corrected signal R_{H-SUM} which is the output of the limit equalizer 142-5. Then, on the comparator 143-4, the phase of the equalization-corrected signal R_{H-D} which is the output of the limit equalizer 142-4 is compared with the phase of the equalization-corrected signal R_{H-SUM} which is the output of the limit equalizer 142-5.

Then, on the adder 144-1, the phase comparison result of the phase comparator 143-1 and the phase comparison result of the phase comparator 143-3 are added. In the same manner, on the adder 144-2, the phase comparison result of the phase comparator 143-2 and the phase comparison result of the phase comparator 143-4 are added.

Then, on the adder 144-3, the added value of the phase comparison results of the phase comparators 143-2 and 143-4 is subtracted from the added value of the phase comparison results of the phase comparators 143-1 and 143-3, thereby generating a DPD signal R_{DPD}.

Even in the fourth structure example having such a structure, it is possible to receive the various effects that can be received in the first structure example.

(7) Fifth Structure Example of Tracking Control Device

Next, with reference to FIG. 10, an explanation will be given on a fifth structure example of the tracking control device 14 which performs the operation of generating the tracking signal TE described above. FIG. 10 is a block diagram conceptually showing the fifth structure example of the tracking control device 14. Incidentally, a tracking control device 14d in the fifth structure example shown in FIG. 10 uses the DPD quad method of the DPD method to generate the tracking signal TE. Moreover, the same constituents as those of the tracking control device 14 in the first structure example described above will carry the same numerical references, and the detailed explanation thereof will be omitted.

As shown in FIG. 10, the tracking control device 14d in the fifth structure example is provided with a condenser 141-1 and a limit equalizer 142-1, which correspond to the division photodetector 122A; a condenser 141-2 and a limit equalizer 142-2, which correspond to the division photodetector 122B; a condenser 141-3 and a limit equalizer 142-3, which correspond to the division photodetector 122C; a condenser 141-4 and a limit equalizer 142-4, which correspond to the division photodetector 122D; a phase comparator 143-1; a phase comparator 143-2; a phase comparator 143-3; a phase comparator 143-4; an adder 144-1; an adder 144-2; an adder 144-3; and an adder 144-4.

Even in the tracking control device 14d in the fifth structure example, as in the tracking control device 14 in the first structure example, an equalization-corrected signal R_{H-A} is generated on the limit equalizer 142-1. In the same manner, an equalization-corrected signal R_{H-B} is generated on the limit equalizer 142-2. In the same manner, an equalization-corrected signal R_{H-C} is generated on the limit equalizer 142-3. In the same manner, an equalization-corrected signal R_{H-D} is generated on the limit equalizer 142-4.

Then, on the adder 144-4, the equalization-corrected signals R_{H-A}, R_{H-B}, R_{H-C}, and R_{H-D} which are outputted from the four limit equalizers 142-1, 142-2, 142-3, and 144-4, respectively, are added. As a result, a sum equalization-corrected signal R_{H-SUM} is generated.

Then, on the comparator 143-1, the phase of the equalization-corrected signal R_{H-A} which is the output of the limit equalizer 142-1 is compared with the phase of the equalization-corrected signal R_{H-SUM} which is the output of the adder 144-4. In the same manner, on the comparator 143-2, the phase of the equalization-corrected signal R_{H-B} which is the output of the limit equalizer 142-2 is compared with the phase of the equalization-corrected signal R_{H-SUM} which is the output of the adder 144-4. In the same manner, on the comparator 143-3, the phase of the equalization-corrected signal R_{H-C} which is the output of the limit equalizer 142-3 is compared with the phase of the equalization-corrected signal R_{H-SUM} which is the output of the adder 144-4. In the same manner, on the comparator 143-4, the phase of the equalization-corrected signal R_{H-D} which is the output of the limit equalizer 142-4 is compared with the phase of the equalization-corrected signal R_{H-SUM} which is the output of the adder 144-4.

Then, on the adder 144-1, the phase comparison result of the phase comparator 143-1 and the phase comparison result of the phase comparator 143-3 are added. In the same manner, on the adder 144-2, the phase comparison result of the phase comparator 143-2 and the phase comparison result of the phase comparator 143-4 are added.

Then, on the adder 144-3, the added value of the phase comparison results of the phase comparators 143-2 and 143-4 is subtracted from the added value of the phase comparison results of the phase comparators 143-1 and 143-3, thereby generating a DPD signal R_{DPD}.

As described above, in the fifth structure example, the equalization-corrected signals R_{H-A}, R_{H-B}, R_{H-C}, and R_{H-D} which are the outputs of the limit equalizers 142-1, 142-2, 142-3, and 142-4, respectively, are added on the adder 144-4. In other words, in comparison with the fourth structure example in which the read signals R_{RF-A}, R_{RF-B}, R_{RF-C}, and R_{RF-D} which are the inputs to the limit equalizers 142-1, 142-2, 142-3, and 142-4, respectively, are added on the adder 144-4, the arrangement of the limit equalizers 142-1, 142-2, 142-3, and 142-4 and the adder 144-4 is opposite. In addition, in the fifth structure example, the number of the limit equalizers 142 can be reduced, in comparison with the fourth structure example. Even in the fifth structure example having such a structure, it is possible to receive the various effects that can be received in the first structure example.

The present invention is not limited to the aforementioned examples, but various changes may be made, if desired, without departing from the essence or spirit of the invention which can be read from the claims and the entire specification. A tracking signal generating apparatus and method, a recording apparatus and method, a reproducing apparatus and method, and a computer program, all of which involve such changes, are also intended to be within the technical scope of the present invention.

1. A tracking signal generating apparatus for generating a tracking signal for performing tracking control which uses a DPD (Differential Phase Detection) method,
the tracking signal generating apparatus comprising:
a reading device for reading reflected light of a laser beam applied onto a recording medium, thereby obtaining a resulting read signal;
a limit equalizer for limiting an amplitude level of the read signal by a predetermined amplitude value, thereby obtaining an amplitude limit signal, and
for performing a high-frequency emphasis filtering process on the amplitude limit signal, thereby obtaining an equalization-corrected signal; and
a generating device for performing a phase comparison process on the equalization-corrected signal, thereby generating the tracking signal.

2. The tracking signal generating apparatus according to claim 1, wherein
the reading device receives the reflected light in four light-receiving areas obtained by performing division in a direction of travel of the laser beam and in a direction of crossing the direction of travel of the laser beam, thereby obtaining four read signals, and
the limit equalizer limits an amplitude level of each of the four read signals or a signal which is obtained by performing a predetermined arithmetic process on the four read signals, by the amplitude limit value, thereby obtaining the amplitude limit signal.

3. The tracking signal generating apparatus according to claim 2, wherein
the limit equalizer limits an amplitude level of each of the four read signals by the amplitude limit value, thereby obtaining four amplitude limit signals,
the limit equalizer performs the high-frequency emphasis filtering process on each of the four amplitude limit signals, thereby obtaining four equalization-corrected signals, and
the generating device uses a direct method as the phase comparison process to generate the tracking signal, the direct method (i) comparing phases of two equalization-corrected signals corresponding to two light-receiving areas of the four light-receiving areas located on a forward side of the direction of travel of the laser beam and (ii) comparing phases of two equalization-corrected signals corresponding to two light-receiving areas of the four light-receiving areas located on an opposite side of the direction of travel of the laser beam.

4. The tracking signal generating apparatus according to claim 2, wherein
the limit equalizer limits an amplitude level of each of the four read signals by the amplitude limit value, thereby obtaining four amplitude limit signals,
the limit equalizer performs the high-frequency emphasis filtering process on each of the four amplitude limit signals, thereby obtaining four equalization-corrected signals, and
the generating device uses a pure method as the phase comparison process to generate the tracking signal, the pure method comparing (i) a phase of a signal obtained by adding two equalization-corrected signals corresponding to two light-receiving areas of the four light-receiving areas located at first diagonal positions and (ii) a phase of a signal obtained by adding two equalization-corrected signals corresponding to two light-receiving areas of the four light-receiving areas located at second diagonal positions.

5. The tracking signal generating apparatus according to claim 2, wherein
the limit equalizer limits an amplitude level of each of a signal obtained by adding two read signals corresponding to two light-receiving areas of the four light-receiving areas located at first diagonal positions and a signal obtained by adding two read signals corresponding to two light-receiving areas of the four light-receiving areas located at second diagonal positions, by the amplitude limit value, thereby obtaining two amplitude limit signals,
the limit equalizer performs the high-frequency emphasis filtering process on each of the two amplitude limit signals, thereby obtaining two equalization-corrected signals, and
the generating device uses a pure method of comparing phases of the two equalization-corrected signals, as the phase comparison process to generate the tracking signal.

6. The tracking signal generating apparatus according to claim 2, wherein
the limit equalizer limits amplitude levels of the four read signals and a signal which is obtained by adding the four read signals, by the amplitude limit value, thereby obtaining five amplitude limit signals,
the limit equalizer performs the high-frequency emphasis filtering process on the five amplitude limit signals, thereby obtaining five equalization-corrected signals, and
the generating device uses a quad method of comparing (i) a phase of each of four of the five equalization-corrected signals corresponding to the four read signals and (ii) a phase of one of the five equalization-corrected signals corresponding to the signal obtained by adding the four read signals, to generate the tracking signal.

7. The tracking signal generating apparatus according to claim 2, wherein
the limit equalizer limits an amplitude level of each of the four read signals by the amplitude limit value, thereby obtaining four amplitude limit signals,
the limit equalizer performs the high-frequency emphasis filtering process on the four amplitude limit signals, thereby obtaining four equalization-corrected signals, and
the generating device uses a quad method of comparing (i) a phase of each of the four equalization-corrected signals and (ii) a phase of a signal obtained by adding the four equalization-corrected signals, to generate the tracking signal.

8. (canceled)

9. A reproducing apparatus for reproducing data recorded on a recording medium while generating a tracking signal for performing tracking control which uses a DPD (Differential Phase Detection) method,
the reproducing apparatus comprising:
a reading device for reading reflected light of a laser beam applied onto the recording medium, thereby obtaining a resulting read signal;
a limit equalizer for limiting an amplitude level of the read signal by a predetermined amplitude value, thereby obtaining an amplitude limit signal and
for performing a high-frequency emphasis filtering process on the amplitude limit signal, thereby obtaining an equalization-corrected signal;
a generating device for performing a phase comparison process on the equalization-corrected signal, thereby generating the tracking signal; and
a reproducing device for reproducing the data recorded on the recording medium while performing the tracking control on the basis of the generated tracking signal.

10. (canceled)

11. A computer readable recording medium recording thereon a computer program for controlling a computer provided in a tracking signal generating apparatus for generating a tracking signal for performing tracking control which uses a DPD (Differential Phase Detection) method, the tracking signal generating apparatus comprising: a reading device for reading reflected light of a laser beam applied onto a recording medium, thereby obtaining a resulting read signal; a limit equalizer for limiting an amplitude level of the read signal by a predetermined amplitude value, thereby obtaining an amplitude limit signal and for performing a high-frequency emphasis filtering process on the amplitude limit signal, thereby obtaining an equalization-corrected signal; and a generating device for performing a phase comparison process on the equalization-corrected signal, thereby generating the tracking signal,
the computer program making the computer function as at least one portion of the reading device, the limit equalizer, and the generating device.

12. A computer readable recording medium recording thereon a computer program for controlling a computer provided in a reproducing apparatus for reproducing data recorded on a recording medium while generating a tracking signal for performing tracking control which uses a DPD (Differential Phase Detection) method, the reproducing apparatus comprising: a reading device for reading reflected light of a laser beam applied onto the recording medium, thereby obtaining a resulting read signal; a limit equalizer for limiting an amplitude level of the read signal by a predetermined amplitude value, thereby obtaining an amplitude limit signal and for performing a high-frequency emphasis filtering process on the amplitude limit signal, thereby obtaining an equalization-corrected signal; a generating device for performing a phase comparison process on the equalization-corrected signal, thereby generating the tracking signal; and a reproducing device for reproducing the data recorded on the recording medium while performing the tracking control on the basis of the generated tracking signal,
the computer program making the computer function as at least one portion of the reading device, the limit equalizer, the generating device, and the reproducing device.
